(19) United States
(12) Patent Application Publication
(10) Pub. No.: US 2004/0045537 A1
(43) Pub. Date: Mar. 11, 2004

(54) High-pressure fuel pump for a fuel system of direct injection internal combustion engine, fuel system and internal combustion engine

(76) Inventors: Helmut Simon, Goeppingen (DE); Helmut Haberer, Gerlingen-Gehenbuehl (DE)

Correspondence Address: RONALD E. GREIGG, GREIGG & GREIGG P.L.L.C., 1423 POWHATAN STREET, UNIT ONE, ALEXANDRIA, VA, 22314, US

(21) Appl. No.: 10/311,533

(22) PCT Filed: Apr. 10, 2002
(86) PCT No.: PCT/DE02/01317

(51) Int. Cl. F02M 37/04

(52) U.S. Cl. 123/495

(57) ABSTRACT

A high-pressure fuel pump (10) is used for a fuel system of a direct-injection internal combustion engine. It includes a housing (12) as well as a low-pressure inlet (18). A high-pressure outlet (20) is also present, which can be connected to a fuel collection line (22). To enable the most compact, small embodiment possible of the high-pressure fuel pump (10), it is proposed that the fuel collection line (22) be integrated into the housing (12) of the high-pressure fuel pump (10).

### PRIOR ART

The invention first relates to a high-pressure fuel pump for a fuel system of a direct-injection internal combustion engine, having a housing, having a low-pressure inlet and having a high-pressure outlet which is connectable to a fuel collection line.

One such high-pressure fuel pump is known on the market. It comprises a conventional radial piston pump that is driven directly by the engine via a mechanical connection. The known radial piston pump, via a fuel line, pumps into a fuel collection line, which is also known generally as a “rail”. The fuel is stored in this rail at very high- pressure (several hundred bar). From the rail, individual branch lines branch off, leading to the individual injection valves at the combustion chambers of the engine.

The object of the present invention is to refine a high-pressure fuel pump of the type defined at the outset in such a way that it is as small and compact in structure as possible and can be produced inexpensively.

In a high-pressure fuel pump of the type defined at the outset, this object is attained in that the fuel collection line is integrated into the housing of the high-pressure fuel pump.

### ADVANTAGES OF THE INVENTION

By integrating the fuel collection line with the housing of the high-pressure fuel pump, the course taken by the fuel from the high-pressure outlet to the fuel collection line is extremely short. This in turn reduces the flow losses between the high-pressure fuel pump and the fuel collection line, so that for the same pressure in the fuel collection line, the moving parts of the high-pressure fuel pump can be made smaller. Moreover, it is no longer necessary to provide a special high-pressure fuel line between the high-pressure fuel pump and the fuel collection line. This reduces the costs.

Advantageous refinements of the invention are defined by dependent claims.

In a first refinement, it is stated that the high-pressure fuel pump includes a pump part that is rotatable about a rotationally fixed shaft, and the fuel collection line is disposed at least in some regions in the rotationally fixed shaft, in particular coaxially to the rotationally fixed shaft. This high-pressure fuel pump is especially compact in structure, since in it, the space required anyway for the shaft is used to accommodate at least part of the fuel collection line.

This can be achieved especially easily then if the high-pressure fuel pump includes a radial piston pump. The courses between the high-pressure outlet and the fuel collection line can then be kept especially short if the radial piston pump is a radially inward-pumping radial piston pump. In this case, the fuel collection line can be connected directly to the high-pressure outlet of the radial piston pump.

The radial piston pump can furthermore include a pump chamber, in which a rotor is disposed that is supported rotatably on a shaft disposed eccentrically to the longitudinal axis of the pump chamber; that the pump chamber can be defined radially by a rotatable ring; and that at least one piston can be provided, which is disposed radially displaceably in the rotor and rests with one radial end on the rotatable ring. A radial piston pump of this kind with a rotatable ring operates mechanically with especially little loss and can therefore, for generating a certain pressure in the fuel collection line, be relatively small in size.

This advantage becomes still greater if the rotatable ring is supported by an encompassing roller bearing.

The refinement of the high-pressure fuel pump of the invention which includes a prefeed pump and a main feed pump disposed fluidically downstream of the prefeed pump, which main feed pump pumps into the high-pressure outlet is especially preferred. With this kind of two-stage high-pressure fuel pump, it is possible with a compact structure to achieve an especially high pressure level at the high-pressure outlet.

It is especially preferred if the prefeed pump includes a vane cell pump, and the main feed pump includes a radial piston pump. A vane cell pump has very good efficiency at low to medium pressures, which conversely the radial piston pump is especially well suited for compression from medium to high pressures.

It is also proposed that the annular chamber of the radial piston pump, formed between the rotor and the radially outer wall of the pump chamber, communicates fluidically with the outlet side of the prefeed pump via a first throttle and a with an outlet via a second throttle. By suitable adaptation of the throttles, the pressure in the annular chamber is less than the pressure in the inlet to the radial piston pump. This reinforces the aspiration motion of the pistons during the intake stroke.

It is also especially preferred that the prefeed pump and the main feed pump are driven by a common shaft. Such a high-pressure fuel pump is also especially compact in structure.

It is also proposed that the housing is in multiple parts. This facilitates both the production of individual parts and the production of the bores present in the housing, through which bores the fuel is meant to flow.

The refinement in which the fuel collection line is provided in a housing part, whose outer contour, in one region, forms the stationary shaft can also be used. Such a part is relatively simple to produce and inexpensively unites two functions in one part.

The housing part in which the fuel collection line is provided can in turn be in multiple parts. In this case, the recess that forms the fuel collection line can be made more easily and can also have a complex geometry, which optimally utilizes the available space in the housing part.

The refinement in which a pressure limiting valve is disposed at the fuel collection line is also preferred. Moreover, the fuel line, which leads away from the pressure limiting valve, can be extended over a short course to the low-pressure inlet, for instance. This can be achieved by suitable bores in the housing. Expensive additional operations to produce a fluid communication thus become unnecessary.

A pressure sensor can also be disposed at the fuel collection line. This makes it possible to monitor the actual pressure prevailing in the fuel collection line, so that any malfunction of the high-pressure fuel pump can be detected immediately and suitable steps can be initiated.

The present invention also relates to a fuel system having a fuel tank, having at least one injection valve that injects the fuel directly into the combustion chamber of an internal combustion engine, having at least one high-pressure fuel pump, and having a fuel collection line to which the injection valve is connected.

In such a fuel system, in order to lower the production costs, it is proposed that the high-pressure fuel pump be embodied as defined above. In that case, the number of separate parts can be reduced, as can the expense required to produce the individual fuel connections.

Finally, the invention relates to an internal combustion engine, having at least one combustion chamber into which the fuel is injected directly.

To reduce the production costs for an internal combustion engine of this kind, it is proposed that the engine have a fuel system of the type defined above. Since because of the reduced number of separate parts and the reduced number of fluid connections to be produced this fuel system can be produced more easily, the total cost of the engine is reduced as a result.

### DRAWING

Below, exemplary embodiments of the invention are described in detail in conjunction with the accompanying drawing. Shown in the drawing are:

FIG. 1, a longitudinal section through a first exemplary embodiment of a high-pressure fuel pump with a multi-part housing;

FIG. 2, a fragmentary section taken along the line II-II in FIG. 1;

FIG. 3, a longitudinal section, similar to FIG. 1, through a secod exemplary embodiment of a high-pressure fuel pump;

FIG. 4, a longitudinal section, similar to FIG. 1, of a third exemplary embodiment of a high-pressure fuel pump; and

FIG. 5, a basic illustration of an internal combustion engine having a fuel system using the high-pressure fuel pump of FIG. 1.

### DESCRIPTION OF THE EXEMPLARY EMBODIMENTS

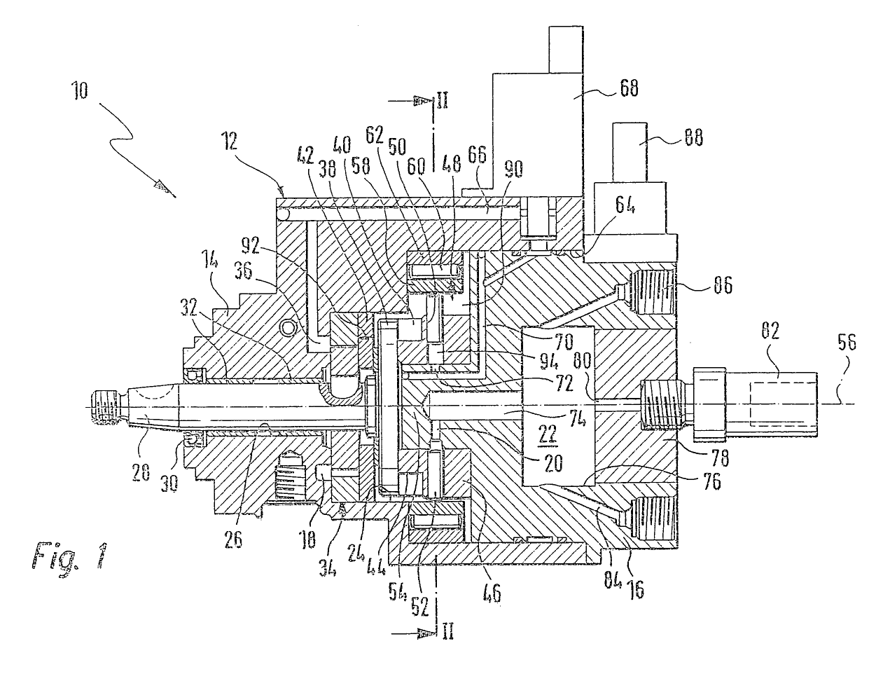

In FIG. 1, a high-pressure fuel pump is identified overall by reference numeral 10. It includes a housing 12 that is constructed in multiple parts. The housing 12 includes one part 14, disposed essentially on the left in FIG. 1, and one part 16, disposed essentially on the right in FIG. 1. The high-pressure fuel pump 10 includes a low- pressure inlet 18, which is connected to a fuel line not shown in FIG. 1. The high-pressure fuel pump 10 further includes a high-pressure outlet 20, to which a fuel collection line 22 (also called a “rail”) is connected directly. The fuel collection line 22 is integrated with the part 16, shown on the right in FIG. 1, of the housing 12 of the high-pressure fuel pump 10.

A step-shaped recess 24 is made in the left-hand part 14 of the housing 12. A shaft 28 is supported via a bearing 30 and sealing rings 32 in the region of the step-like recess 24 that has the smallest diameter (reference numeral 26). A vane cell pump 34 is driven by the shaft 28. The vane cell pump 34 is of conventional design. It is not described in detail here. The vane cell pump 34 acts as a prefeed pump, which pumps from the crescent-shaped low-pressure inlet 18 into an also crescent-shaped prefeed pump outlet 36.

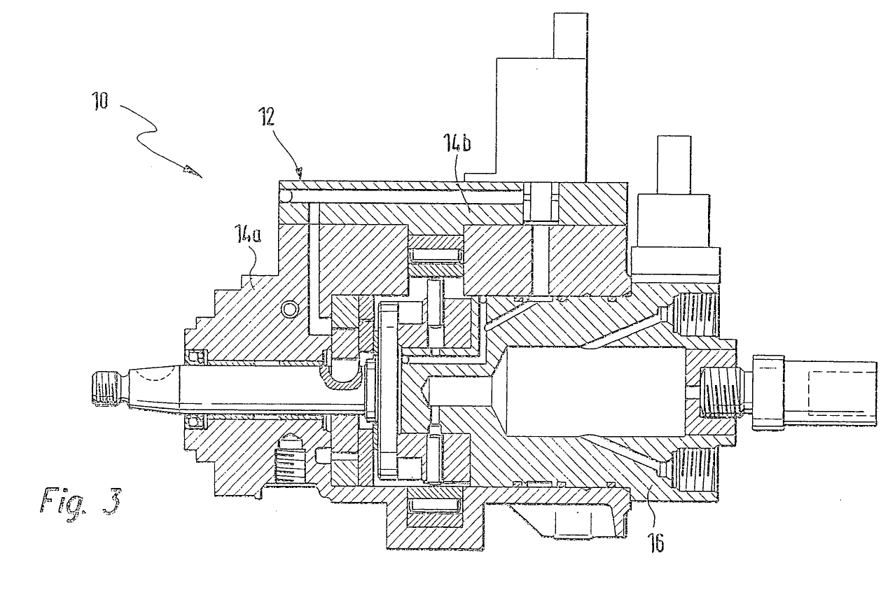

A slaving disk 38 is secured to the right-hand end of the shaft 28, in terms of FIG. 1, and onto it, two drivers 40 extending in the axial direction are formed. An annular sealing element 42 is provided between the slaving disk 38 and the vane cell pump 34. The drivers 40 engage corresponding recesses 44 in a rotor 46, and the rotor is part of a radial piston pump 48 acting as a main feed pump (see FIG. 3).

The rotor 46 is an annular part, into the wall of which radially extending through bores 50 are made. The through bores 50 are distributed over the circumference of the rotor 46. Feed pistons 52 are guided radially displaceably in these bores. The length of the feed pistons 52 is approximately equivalent to the radial wall thickness of the rotor 46.

The rotor 46 is mounted on a peglike protrusion 54 that is formed by the outer contour of the right-hand part 16 of the housing 12. The protrusion 54 thus forms a shaft on which the rotor 46 is rotatably retained. The longitudinal axis of the shaft 54 is aligned with the longitudinal axis of the shaft 28. Both axes are identified by reference numeral 56.

A ring 58 is disposed radially on the outside around the rotor 46. The inside diameter of the ring 58 is greater than the outside diameter of the rotor 46. The longitudinal axis (not shown) of the ring 58 is parallel to but radially offset from the longitudinal axis 56 of the shaft 54. The rotor 46 is thus disposed eccentrically relative to the ring 58. The ring 58 is supported rotatably via a needle bearing 60 relative to an outer ring 62. The outer ring 62 is in turn fitted in a manner fixed against relative rotation into a region 64 of the step-like recess 24 in the left-hand part 14.

From the prefeed pump outlet 36, a flow conduit 66 leads to a metering unit 68. The flow conduit 66 is contained entirely in the left-hand part 14. From the metering unit 68, a flow conduit 70 in the part 16 of the housing 12 leads to a crescent-shaped main feed pump inlet 72. The metering unit is essentially a magnet valve that controls the inflow of fuel to the main feed pump 48.

The high-pressure outlet 20 is also embodied in crescent form. The fuel collection line 22 has one portion 74 of smaller diameter, which is connected directly to the high-pressure outlet 20. It also has one portion 76 of greater diameter. Toward the outside, the fuel collection line 22 is closed with a stopper piece 78, which is screwed into the portion 76 of the fuel collection line 22.

In the stopper piece 78, there is a central stepped bore 80, into whose portion of larger diameter (not identified by a reference numeral) a pressure limiting valve 82 is screwed. From the portion 76 of the fuel collection line, a plurality of branch lines 84 also branch off; they open into threaded connections 86 for valve connections, not shown in the drawing. A pressure sensor 88 is also secured to the right-hand part 16 of the housing 12; in a manner not visible in the drawing, it communicates fluidically with the fuel collection line 22.

Between the rotor 46 and the ring 58, an annular chamber 90 is formed. Via a flow throttle 92 in the sealing element 42, this annular chamber communicates fluidically with the prefeed pump outlet 36. Via a further flow throttle, not visible, the annular chamber 90 communicates with an outlet that is at normal atmospheric pressure.

The high-pressure fuel pump 10 functions as follows: From the low-pressure inlet 18, the fuel is precompressed to a certain level via the vane cell pump 34. This pressure level prevails at the prefeed pump outlet 36. The precompressed fuel is pumped via the flow conduit 66, the metering unit 68, and the flow conduit 70 to the main feed pump inlet 72. Since because of the flow throttle 92 and the other flow throttle, not visible, the pressure in the annular chamber 90 between the rotor 46 and the ring 58 is less than the pressure at the main feed pump inlet 72, the feed pistons 52, upon a rotation of the rotor 46, initially move radially outward. This motion is reinforced by centrifugal force.

Thus the corresponding feed chamber 94 located in the through bores 50 is filled with fuel. By means of the shaft 28, the rotor 46 is rotated onward, so that the fuel-filled feed chamber 94 is disconnected from the crescent-shaped main feed pump inlet 72. In the course of the motion, the feed chamber 94 is made to communicate instead with the high-pressure outlet 20. Because of the eccentricity between the rotor 46 and the ring 58, the feed piston 52 is simultaneously pressed radially inward, so that the fuel located in the feed chamber 94 is pumped into the fuel collection line 22 via the high-pressure outlet 20.

In the fuel collection line 22, the fuel is stored at high pressure. From the fuel collection line 22, the fuel can be output again via the branch lines 84 and the threaded connections 86. The pressure in the fuel collection line 22 is limited to a maximum value by the pressure limiting valve 82. The monitoring of the pressure in the fuel collection line 22 is done by the pressure sensor 88.

The exemplary embodiment shown in FIG. 3 will now be described. In it, only those parts that differ from the first exemplary embodiment are identified by reference numerals. All the other parts are essentially identical.

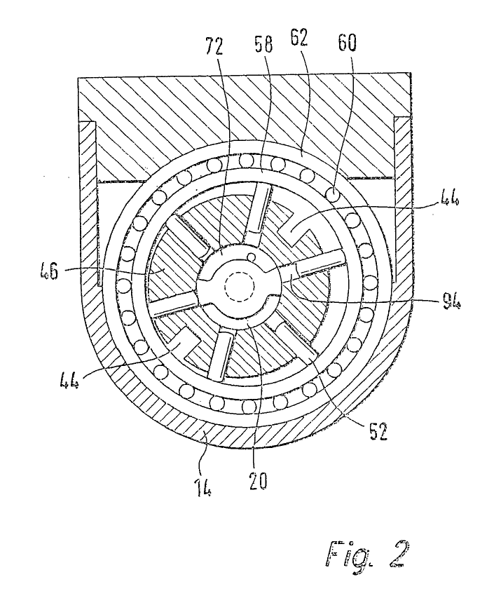

The primary difference between the exemplary embodiment shown in FIG. 3 and the exemplary embodiment of a high-pressure fuel pump 10 shown in FIGS. 1 and 2 is that the housing 12 of the high-pressure fuel pump 10 shown in FIG. 3 is not in only two parts but instead is in three parts. The corresponding parts are identified by reference numerals 14a, 14b, and 16.

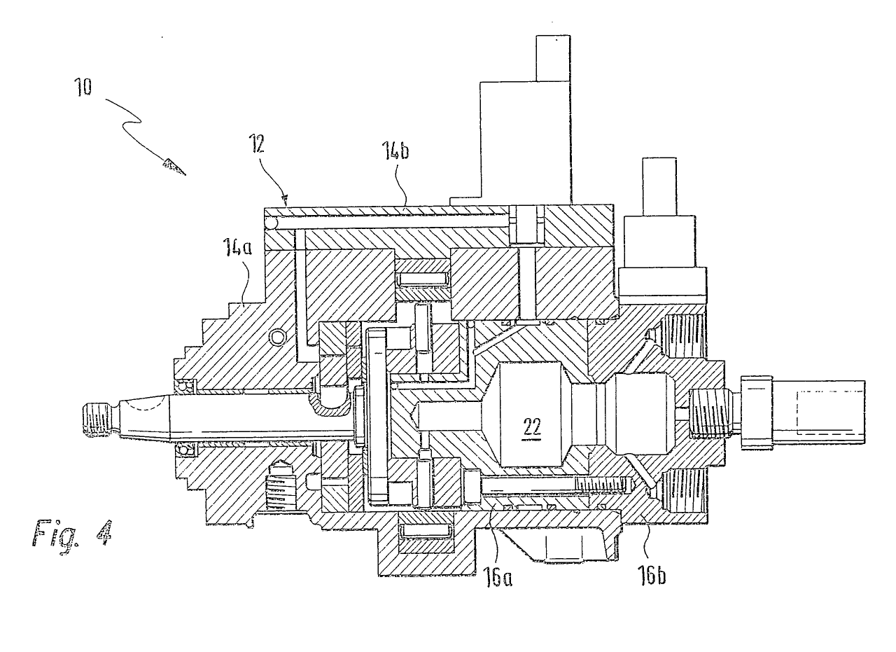

In the exemplary embodiment of a high-pressure fuel pump 10 shown in FIG. 4, the same comment about the reference numerals as for FIG. 3 applies. In contrast to the exemplary embodiment shown in FIG. 3, in the exemplary embodiment of FIG. 4 the housing 12 is not merely in three parts but instead is in four parts. These parts are identified by reference numerals 14a, 14b, 16a and 16b. In addition, the fuel collection line 22 is designed in a way that is optimized volumetrically.

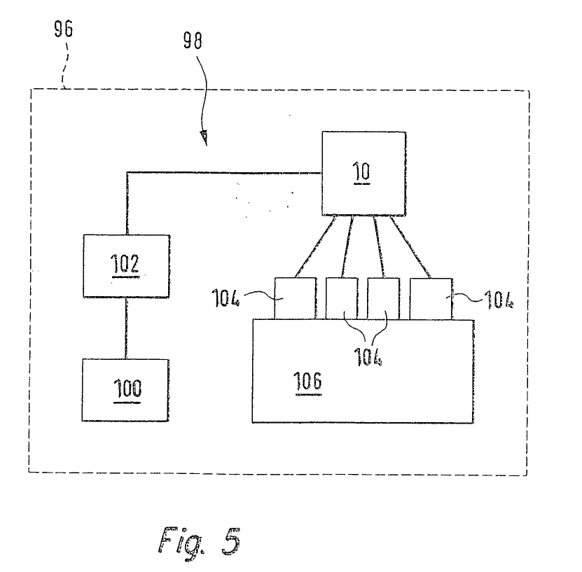

In FIG. 5, an internal combustion engine is schematically shown. It is identified by reference numeral 96. It includes a fuel system 98. The fuel system in turn contains a fuel tank 100, from which the fuel is pumped, via an electric fuel pump 102, to the high-pressure fuel pump 10. This high-pressure fuel pump is embodied as in FIG. 1. A total of four injection valves 104 are connected to the high-pressure fuel pump 10 and inject the fuel directly into a combustion chamber 106.

1. A high-pressure fuel pump (10) for a fuel system (98) of a direct-injection internal combustion engine (96), having a housing (12), having a low-pressure inlet (18) and having a high-pressure outlet (20) which is connectable to a fuel collection line (22), characterized in that the fuel collection line (22) is integrated into the housing (12) of the high-pressure fuel pump (10).

2. The high-pressure fuel pump (10) of claim 1, characterized in that it includes a pump part (46) that is rotatable about a rotationally fixed shaft (54), and the fuel collection line is disposed at least in some regions in the rotationally fixed shaft (54), in particular coaxially to the rotationally fixed shaft (54).

3. The high-pressure fuel pump (10) of claim 2, characterized in that it includes a radial piston pump (48).

4. The high-pressure fuel pump (10) of claim 3, characterized in that the radial piston pump (48) is a radially inward-pumping radial piston pump.

5. The high-pressure fuel pump (10) of one of claims 3 or 4, characterized in that the radial piston pump (48) includes a pump chamber, in which a rotor (46) is disposed that is supported rotatably on a shaft (54) disposed eccentrically to the longitudinal axis of the pump chamber; that the pump chamber is defined radially by a rotatable ring (58); and that at least one piston (52) is provided, which is disposed radially displaceably in the rotor (46) and rests with one radial end on the rotatable ring (58).

6. The high-pressure fuel pump (10) of claim 5, characterized in that the rotatable ring (58) is supported by an encompassing roller bearing (60).

7. The high-pressure fuel pump (10) of one of the foregoing claims, characterized in that it includes a prefeed pump (34) and a main feed pump disposed fluidically downstream of the prefeed pump (34), which main feed pump pumps into the high-pressure outlet (20).

8. The high-pressure fuel pump (10) of claim 7, characterized in that the prefeed pump includes a vane cell pump (34), and the main feed pump includes a radial piston pump (48).

9. The high-pressure fuel pump (10) of claims 5 and 8, characterized in that the annular chamber (90) of the radial piston pump (48), formed between the rotor (46) and the radially outer wall of the pump chamber, communicates fluidically with the outlet side (36) of the prefeed pump (34) via a first throttle (92) and a with an outlet via a second throttle.

10. The high-pressure fuel pump (10) of one of claims 7-9, characterized in that the prefeed pump (34) and the main feed pump (48) are driven by a common shaft (28).

11. The high-pressure fuel pump (10) of one of the foregoing claims, characterized in that the housing (12) is in multiple parts (14, 16).

12. The high-pressure fuel pump (10) of claim 11, characterized in that the fuel collection line (22) is provided in a housing part (16), whose outer contour, in one region, forms the stationary shaft (54).

13. The high-pressure fuel pump (10) of claim 12, characterized in that the housing part (16) in which the fuel collection line (22) is provided is in turn in multiple parts (16a, 16b).

14. The high-pressure fuel pump (10) of one of the foregoing claims, characterized in that a pressure limiting valve (88) is disposed at the fuel collection line (22).

15. The high-pressure fuel pump (10) of one of the foregoing claims, characterized in that a pressure sensor (88) is disposed at the fuel collection line (22).

16. A fuel system (98) having a fuel tank (100), having at least one injection valve (104) that injects the fuel directly into the combustion chamber (106) of an internal combustion engine (96), having at least one high-pressure fuel pump (10), and having a fuel collection line (22) to which the injection valve (104) is connected, characterized in that the high-pressure fuel pump (10) is embodied in accordance with one of claims 1-15.

17. An internal combustion engine (96), having at least one combustion chamber (106) into which the fuel is injected directly, characterized in that it has a fuel system (98) in accordance with claim 16.
